(19) United States
(12) Patent Application Publication
(10) Pub. No.: US 2025/0348903 A1
(43) Pub. Date: Nov. 13, 2025

(54) PRIVACY-CONSCIOUS CONTENT AND ADVERTISEMENT TARGETING

(71) Applicant: 2NO, Inc., New York, NY (US)

(72) Inventors: Jeffrey NICHOLS, New York, NY (US); David GESSEL, Oakland, CA (US)

(21) Appl. No.: 19/207,213

(22) Filed: May 13, 2025

Related U.S. Application Data
(60) Provisional application No. 63/646,596, filed on May 13, 2024.

(51) Int. Cl. G06Q 30/0251

(52) U.S. Cl. CPC G06Q 30/0257

(57) ABSTRACT

Described herein are exemplary devices, apparatuses, systems, methods, and non-transitory storage media for targeting content and advertisements while protecting user privacy.

### CROSS-REFERENCE TO RELATED APPLICATIONS

This application claims benefit of U.S. Provisional Application No. 63/646,596, filed May 13, 2024, the contents of which are incorporated herein by reference in their entirety.

### TECHNICAL FIELD

This disclosure generally relates to targeting content and advertisements while protecting user privacy and brand image.

### BACKGROUND

Digital advertising may comprise a non-user-requested block of content inserted by an advertiser into a user-requested block of content made available by a publisher on behalf of the advertiser. The purpose may be bringing a specific message, typically a solicitation for a commercially available good or service, to the attention of the user. The publisher generally generates some revenue from the presentation of such advertisements, which may be typically scaled according to the degree to which the advertiser's economic interests are furthered by the process, a measure known as “ad performance.” There may be a correlation between ad performance and the degree to which an ad is for a product or service the user is interested in purchasing or for which the user is likely to be a future customer.

In digital publications, a common practice is for an advertiser to engage the services of an ad broker, which can be a partially or completely automated software tool that determines optimized matches between an inventory of advertisements, and publications in which to display those ads. The selection of placement is generally determined by a combination of factors, for example, including an optimization of a bid price the advertiser might offer to place their ad, which may be uniform or vary by placement-specific criterion, and a prediction of the performance of the ad, given a variety of criteria. The criteria may include assessments of user-specific interests reflective of the probability that the ad in question will yield a response favorable to the advertiser from the user to whom the ad is shown.

Ad placement systems have developed sophisticated mechanisms around predicting user interest based on user activity. Some systems may rely on aggregation of detailed, individualized information relevant to advertising targeting. While some such systems have been successful, many users and many legislators world-wide have expressed privacy concerns regarding the reach and scope of the information being collected and utilized by these systems. In some cases, users have successfully advocated for legislation to limit the data that may legally be collected. In response to user demand and to forestall more limiting legislation, entities providing hardware and software through which users interact with digital publications have increasingly created technological barriers to the collection of privacy compromising data.

As an example, a person may have taken steps that indicate interest in buying a new car, such as performing a web search for car dealerships of a specific brand combined with reading review articles about the same or a similar brand. Each of these steps has been recorded by the web site offering the content, those recordings being aggregated across sites, and that aggregate data being provided to ad brokers who, on detecting that the same user visits additional sites, prioritize the display of ads for that brand or competing brands out of a given ad inventory.

As these steps to protect privacy have been implemented, ad performance that relied on data collected in a manner that compromised user privacy in conflict with increasing legal constraints, or by relying on technological access since denied by technology providers, has declined, or is predicted to decline.

As publishers have become aware of the degree to which their selected technology stacks compromise the privacy of their users and that such compromise might lead to user dissatisfaction with their publication or service, they have sought alternative technology stacks that promise similar economic returns without compromising user privacy. Existing solutions have not yet provided a satisfactory solution.

Another issue faces advertisers and publications, as content moves from the print realm, which has high degree of editorial discretion and carefully scrutinized placement with an awareness of the contextual placement of the ad specifically to ensure advertiser satisfaction, to automatic placement, individual editorial discretion is lost. Algorithmic placement to optimize revenue generation is made at the compromise of brand protection, in that placement may be against a contextually relevant block of text but one that is relevant for unwelcome reasons.

As an example, an article about high-performance, gasoline-powered automobiles would likely contain many contextually relevant triggers to display ads for the same, but if the article's primary focus was the harm to the environment such vehicles cause, the contextual juxtaposition is less likely to result in sales and may be considered harmful to the brand.

Existing solutions rely on anti-keyword lists that suppress automatic ad placement. Such keyword lists are manually maintained and prone to failures, ether false positives which reduce revenue for the advertiser and the publication or false negatives which not only reduce revenue on both sides but may cause lasting brand harm.

Existing systems built around statistical latent semantic tools may be limited to fully automated ad optimization because the standard models operate on static document collections. They may not be useful for dynamic analysis of content as is required for ad placement. For example, a short form text such as a “tweet” or an ad copy may be poorly suited to algorithmic or human relevance matching because humans may apply implicit or explicit context to expand the scope of relevance assumptions.

A further limitation of existing statistical latent semantic tools is that the accuracy of such tools in identifying topicality is dependent on the degree of specificity of the semantic terms extracted from the document in identifying topicality. This is a process which has little statistical validity where there is little data from which to infer meaning, such as the short terms and phrases used in advertising copy.

Some large language models are trained using various neural network models such as recurrent, convolutional, and transformer neural networks. While these technologies may be powerful and yield impressive results, the internal mathematical representations require trained crossbar links between each input node and every output node, every node-to-node link representing multiple operations performed for each calculation to get a result from a trained network and far more in training. For a model of a given complexity, a statistical model's computational load increases linearly with the complexity while prior art neural networks have a computational load that increases exponentially with the complexity of the model. Useful large language model networks require substantial computational resources and consume meaningful power per output of results, while in comparison the disclosed method has trivial computational requirements and executes in a few clock cycles.

Another limitation is the cost of each computation, both financial and temporal, in implementing an ad placement optimization strategy using modern artificial intelligence (AI) technology. Cost and performance may represent a significant portion of the marginal value of ad placement, rendering brute force implementations of AI as a direct per-placement optimization algorithm financially impractical in some instances. For example, modern ad placements may generate gross per placement revenues measured in cents, typically 5-10 cents, with marginal profits a 5-10% of that gross revenue, often measured in fractional cents per placement. AI models may charge on the order of $0.02 per 100 words fed into the AI model and $0.08 per 100 words generated by the model. In some cases, this rate would significantly exceed the total net revenue allocated to placement. Typical ads might range from 4-25 words with a typical value of 20 connecting to a landing page with 250-500 words might incur an input charge of $0.10-$0.15, above the gross revenue of the highest volume ads. It is desirable to decrease these costs with respect to revenue.

Another limitation is the latency of existing AI solutions. The latency between prompt input and output received may depend on the number of words processed; for example, latency may range from 0.45 sec to 2.6 sec per 100 words. Latency has financial costs: for example, one study found that every second of latency results in a 7% reduction in the conversion rate. In some cases, large language models may introduce so much latency that any conversion improvement achieved by enhanced placement insight is overwhelmed by the loss of revenue caused by the latency of computation. Accordingly, it is desirable to reduce this latency.

### SUMMARY

Described herein are exemplary devices, apparatuses, systems, methods, and non-transitory storage media for targeting content and advertisements while protecting user privacy and brand image. The disclosed devices, apparatuses, systems, methods, and non-transitory storage media allow content and advertisements to be more accurately targeted while protecting the users' private data and maintaining positive brand image.

As discussed above, existing solutions have not yet provided a satisfactory solution having high advertising performance while protecting user privacy. The disclosed devices, apparatuses, systems, methods, and non-transitory storage media allow improved advertising performance while protecting user privacy. As also discussed above, existing solutions have not yet provided a satisfactory solution for ad placements that protect brand image. The disclosed devices, apparatuses, systems, methods, and non-transitory storage media allow improved brand protection with enhanced algorithmic precision that, for example, does not rely on maintenance of human curated keyword lists.

Additionally, the disclosed devices, apparatuses, systems, methods, and non-transitory storage media achieve these important goals with improved performance by introducing features to natural language parsing tools and extend the utility of these models to dynamic, multi-domain environments. For example, by incorporation of the extended context available in an extended group of objects adds semantic data to improve the reliability of semantic relevance ranking.

Additionally, the disclosed devices, apparatuses, systems, methods, and non-transitory storage media can provide extended content or temporal contextual weighting to relevance computations, to mitigate the impact of atypical or transient content variations, improving the stability of relevance matching and mitigating the impact of contextual outliers.

Additionally, the disclosed devices, apparatuses, systems, methods, and non-transitory storage media can respond dynamically to changing conditions and can be automatically or manually tuned to optimize performance for specific applications, for example to optimize user experience on a publisher's site or optimize the performance of the ads a publisher might run on their site.

In some embodiments, a method comprises receiving a request for a first advertisement for a user; determining one or more domain vectors associated with the user, wherein the one or more domain vectors indicate a suitability of an advertisement for the users; determining from a plurality of advertisements, based on the one or more domain vectors, the first advertisement; and transmitting the first advertisement.

In some embodiments, a method comprises receiving a request for a first advertisement for a content; determining one or more domain vectors associated with the content, wherein the one or more domain vectors indicate a suitability of an advertisement for the content; determining from a plurality of advertisements, based on the one or more domain vectors, the first advertisement for the content; and transmitting the first advertisement for the content.

In some embodiments, a method comprises receiving a plurality of requests a first advertisement from a plurality of users; determining one or more domain vectors associated with each of the users, wherein the one or more domain vectors indicate a suitability of a user for the first advertisement; determining from the plurality of users, based on the one or more domain vectors, the first user; and transmitting the first advertisement to the first user.

In some embodiments, a method comprises receiving a plurality of requests for a first advertisement for a plurality of content; determining one or more domain vectors associated with each of the content, wherein the one or more domain vectors indicate a suitability of a content for the first advertisement; determining from the plurality of content, based on the one or more domain vectors, the first content; and transmitting the advertisement for the first content.

In some embodiments, a method comprises receiving a plurality of requests for a first advertisement for a plurality of content; determining one or more domain vectors associated with each of the content, wherein the one or more domain vectors indicate an adverse suitability of a content for the advertisement; determining from a plurality of content, based on the one or more domain vectors, inappropriate content; and forgoing transmitting the first advertisement for the inappropriate content.

In some embodiments, a non-transitory computer-readable medium stores instructions that, when executed by one or more processors, cause the one or more processors to perform the above methods.

In some embodiments, a system comprises one or more processors configured to perform the above methods.

The embodiments disclosed are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an exemplary system for targeting content and advertisements, in accordance with some embodiments.

FIGS. 2A-2E illustrate exemplary content and advertisement options for a target, in accordance with some embodiments.

FIG. 3 illustrates an exemplary workflow for targeting content and advertisements, in accordance with some embodiments.

FIGS. 4A-4B illustrate exemplary methods for targeting content and advertisements, in accordance with some embodiments.

FIGS. 5A-5B illustrate exemplary advertisements, in accordance with some embodiments.

FIG. 6 illustrates an exemplary system, in accordance with some embodiments.

### DETAILED DESCRIPTION

In the following description of embodiments, reference is made to the accompanying drawings which form a part hereof, and in which it is shown by way of illustration specific embodiments which can be practiced. It is to be understood that other embodiments can be used, and structural changes can be made without departing from the scope of the disclosed embodiments.

Described herein are exemplary devices, apparatuses, systems, methods, and non-transitory storage media for targeting content and advertisements while protecting user privacy and brand image. The disclosed devices, apparatuses, systems, methods, and non-transitory storage media allow content and advertisements to be more accurately targeted while protecting the users' private data and maintaining positive brand image.

As discussed above, existing solutions have not yet provided a satisfactory solution having high advertising performance while protecting user privacy. The disclosed devices, apparatuses, systems, methods, and non-transitory storage media allow improved advertising performance while protecting user privacy. As also discussed above, existing solutions have not yet provided a satisfactory solution for ad placements that protect brand image. The disclosed devices, apparatuses, systems, methods, and non-transitory storage media allow improved brand protection with enhanced algorithmic precision that, for example, does not rely on maintenance of human curated keyword lists.

Additionally, the disclosed devices, apparatuses, systems, methods, and non-transitory storage media achieve these important goals with improved performance by introducing features to natural language parsing tools and extend the utility of these models to dynamic, multi-domain environments. For example, by incorporation of the extended context available in an extended group of objects adds semantic data to improve the reliability of semantic relevance ranking.

Additionally, the disclosed devices, apparatuses, systems, methods, and non-transitory storage media can provide extended content or temporal contextual weighting to relevance computations, to mitigate the impact of atypical or transient content variations, improving the stability of relevance matching and mitigating the impact of contextual outliers.

Additionally, the disclosed devices, apparatuses, systems, methods, and non-transitory storage media can respond dynamically to changing conditions and can be automatically or manually tuned to optimize performance for specific applications, for example to optimize user experience on a publisher's site or optimize the performance of the ads a publisher might run on their site.

In some embodiments, a method comprises receiving a request for a first advertisement for a user; determining one or more domain vectors associated with the user, wherein the one or more domain vectors indicate a suitability of an advertisement for the users; determining from a plurality of advertisements, based on the one or more domain vectors, the first advertisement; and transmitting the advertisement.

In some embodiments, a non-transitory computer-readable medium stores instructions that, when executed by one or more processors, cause the one or more processors to perform the above method.

In some embodiments, a system comprises one or more processors configured to perform the above method.

Examples of the above system and methods are described in more detail below.

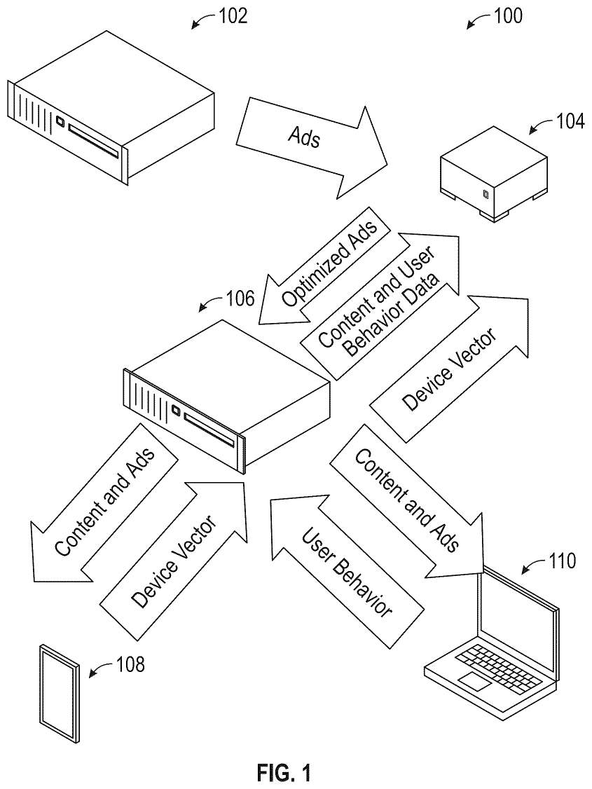

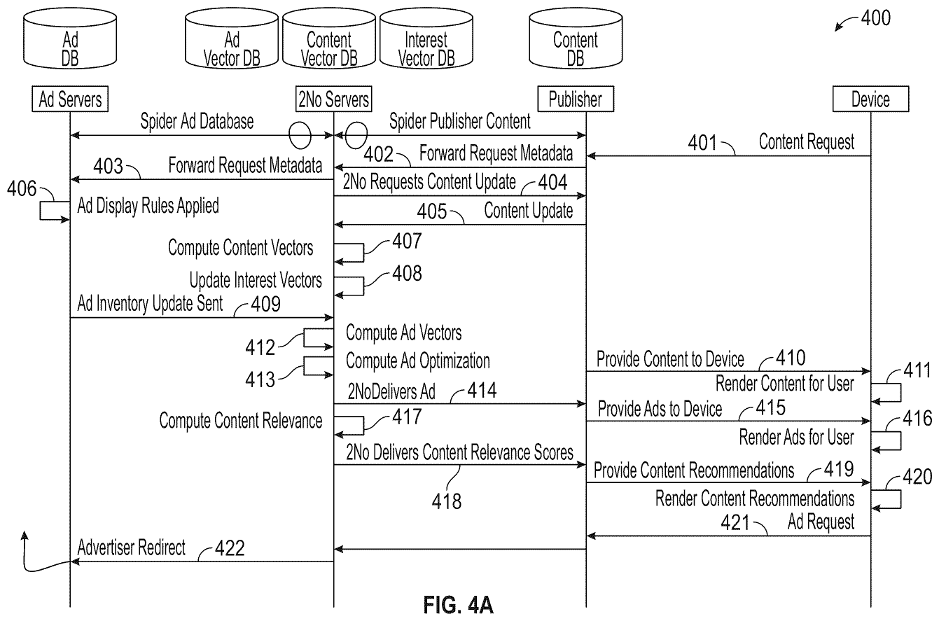

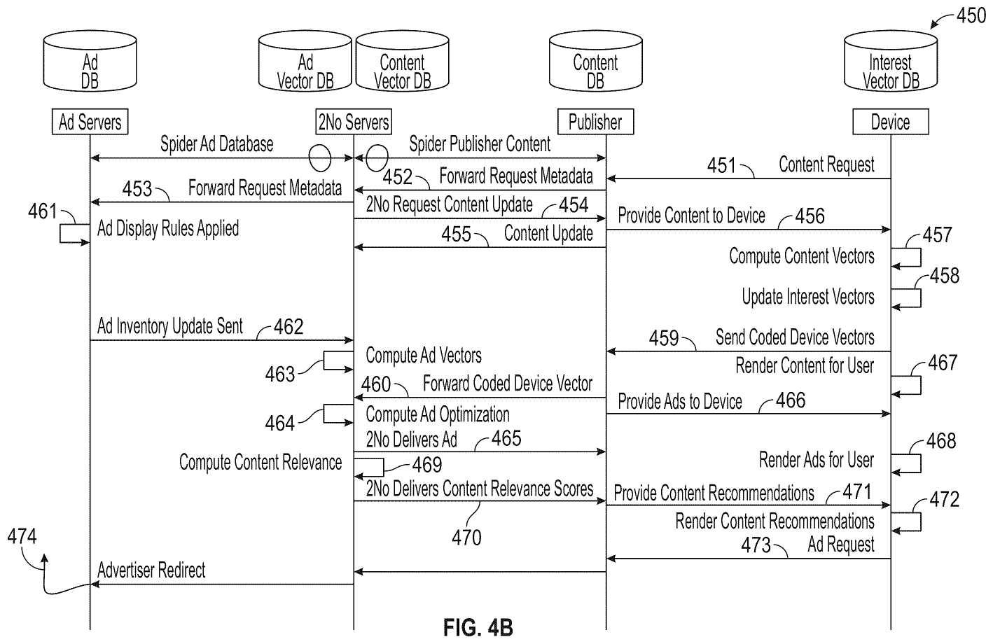

FIG. 1 illustrates an exemplary system 100 for targeting content and advertisements, in accordance with some embodiments. For example, as illustrated, the system 100 comprises devices 102, 104, 106, 108, and 110. The device 102 may be an advertisement server that stores and provides advertisements and/or content. The device 104 may be a device for optimizing content and advertisements, as described herein, and receiving content, user behavior data, and Device Vector (e.g., from devices 108 and 110). Examples of Device Vectors are described in detail below. The device 106 may be a device of a publisher (e.g., as described above) and may receive the optimized advertisements and/or content, the user behavior data, and Device Vector. The device 106 may receive user behavior data and Device Vector from user (e.g., an audience of an advertisement or content) devices, such as devices 108 and 110. The device 106 may provide advertisements and/or content (e.g., that were received from, for example, device 104) to the user devices. Examples of system operation are described in more detail with respect to FIGS. 4A and 4B.

In the example system 100 shown in FIG. 1, one or more of devices 102, 104, 106, 108, 108, and 110 may include or be configured to communicate with a database. As an example, device 102 may include or communicate with a database that stores advertisements and/or content. As another example, device 104 may include or communicate with a database that stores Device Vectors, Content Vectors, Ad Vectors, Campaign Vectors, Brand Vectors, Interest Vectors, Author Vectors, Section Vectors, and/or Publication Vectors, as described herein. Further, one or more of devices 102, 104, 106, 108, 108, and 110 may include or be configured to communicate with an AI processor (e.g., a neural processing unit (NPU) or AI accelerator, such as an NVIDIA H100), which is configured to execute or facilitate the execution of AI workloads, such as neural network operations. For example, device 104 can include or communicate with an AI processor, where the AI processor is utilized for performing neural network operations as described herein.

In some embodiments, device 102 may comprise one or more Ad Servers; device 104 may comprise one or more 2NO Servers; device 106 may comprise one or more servers operated by a publisher; and devices 108 and/or 110 may comprise one or more user devices; such as described herein.

It should be appreciated that the system 100 may include different devices than illustrated and described. For example, operations associated with one illustrated device may be performed by more than one device. As another example, operations associated with two different illustrated devices may be performed by one device.

In some embodiments, the disclosed systems and methods efficiently solve the following problems: given an inventory of ads and a particular user, which ad from that inventory is the user most likely to respond to in a manner consistent with that advertiser's interests?Given an inventory of ads and a particular piece of content, which ad from that inventory when placed alongside that content are users in aggregate most likely to respond to in a manner consistent with that advertiser's interests?

The above inventory and comparisons may be inverted: given an inventory of users and a particular ad, which user from that inventory is the ad most likely to respond to in a manner consistent with that advertiser's interests?Given an inventory of content and a particular ad, which piece of content from that inventory, when the ad is placed alongside it, are users in aggregate most likely to respond to in a manner consistent with that advertiser's interests?

A converse case may be solved by the discloses systems and methods: given an inventory of content and a particular ad, which pieces of content from that inventory, when the ad is placed alongside it, is most likely to create an adverse response inconsistent with that advertiser's interests?

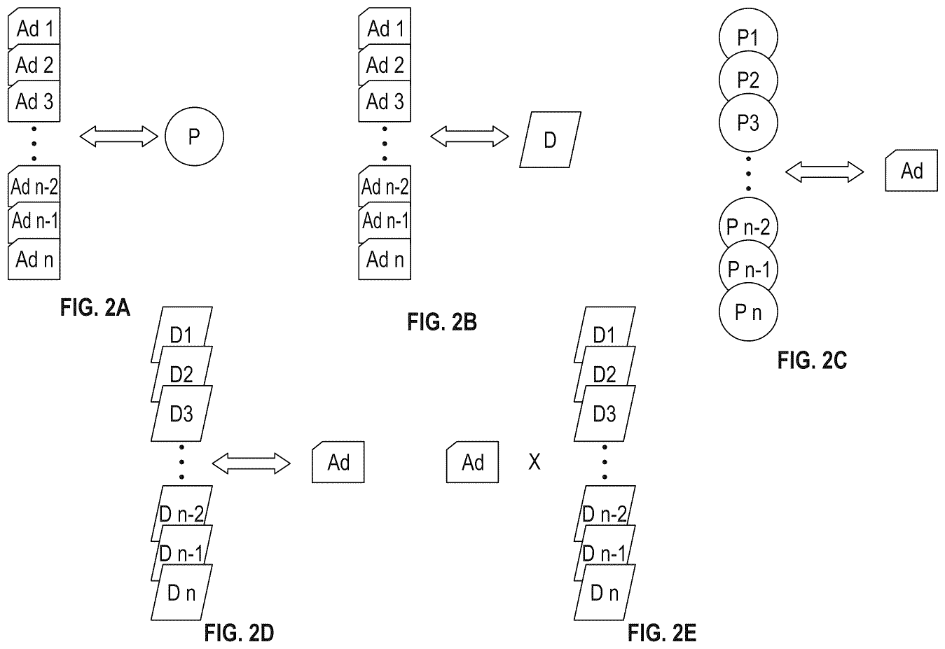

FIGS. 2A-2E illustrate exemplary content and advertisement options for a target, in accordance with some embodiments. For example, each of the above cases is illustrated in FIGS. 2A-2D, respectively. In each of the four cases, the disclosed system is configured to select the best available option from the array of options on the left for the target on the right.

In an adverse case, which is illustrated in FIG. 2E, the disclosed system is configured to determine the measure of predicted adverse response and to reject all ads above some critical threshold of adverseness.

In some embodiments, the disclosed devices, apparatuses, systems, methods, and non-transitory storage media achieve these important goals with improved performance by introducing features to natural language parsing tools and extend the utility of these models to dynamic, multi-domain environments.

In some embodiments, extensions are introduced, and the extensions enable computationally efficient statistical latent semantic models to be applied to real time, dynamic optimization of advertising.

For example, a feature of statistical semantic analysis tools is extracting words and phrases from a collection of texts to be analyzed and assigning weights to those words and phrases. These elements may be referred to as n-grams or tokens, a symbolic sequence often delineated by a stop character, such as a space, where a single word is a 1-gram, a two word phrase a 2-gram, and the general term for grams of variable length are n-grams.

In some embodiments, stop words and other low value n-grams are removed. They may be words such as “and” or “a”—terms that add no discriminatory value as they are either simply structural baggage or because they're universal across the language. So, frequency of use in a particular document may add little or no additional topical discrimination.

Lemmatization is another function that can be used to reduce the complexity of computations. In some embodiments, the disclosed systems use both static lemmatization models taken from standardized semantic models and statistically derived topically relevant lemmatization extracted from latent indicators in text. This advantageously reduces complexity and improves results by merging lexically synonymous n-grams into functional lemma.

Lexical n-grams may be used for semantic analysis of verbal content. In some embodiments, for efficiency and to improve user privacy, the disclosed system computes a hash of each lemmatized n-gram and uses that value for forward calculations of topic weighting. In some embodiments, in a step which includes a hashing function, the operation may be performed by a CPU of a client device, which may comprise cryptographic acceleration modules, such as AES-NI.

The disclosed system may be fully compatible with and anticipate the integration of the equivalent of visual and acoustic lemma, similarly reduced to hashed indices, as equivalent n-grams. In some embodiments, machine assisted extraction of symbolic, typically verbal summaries of images, video, and music and other otherwise non-verbal communication modalities, is performed by neural networks, such as deep convolutional neural networks and transformer neural networks.

In some embodiments, non-neural network-based methods of extracting the symbolic significance from non-verbal media may be used. For example, spatial latent Dirichlet allocation can be used to integrate “topics” extracted from sub-blocks of images, video, or audio media associated with articles or ads. Statistically extracted non-verbal media topics may or may not be meaningfully comparable except within consistent media types e.g., images with images, audio with audio. In some embodiments, the disclosed system is configured to perform the extraction of verbal or symbolic meaning from visual, acoustic, or other non-verbal media and incorporation of that extracted symbolic or verbal meaning into the computation of topical affinity.

Advantageously, n-grams have statistically discoverable significance in differentiating between different topical intents and have differing significance in understanding context. Discovering the topics inherent in a corpus may be performed via latent Dirichlet allocation, or LDA. LDA is one statistical linguistic technique for extracting latent topics, in an abstract sense, from a data set, typically symbolic or verbal.

For example, a proper noun may be more topically relevant as an indicator of topicality than common connector words. Further, n-gram X may differentiate, for instance, topic A from topic B, but may be used with similar frequency in topic B and topic C and therefore have little value in discriminating topics B from topic C. Frequency of use of n-gram Y may differentiate topic B from topic C, but be used with similar frequency in topics A and B and might not appear at all in any document related to certain other topics. The disclosed system may advantageously determine which n-grams are most relevant to topical differentiation and the weighting of them in a more computationally efficient manner.

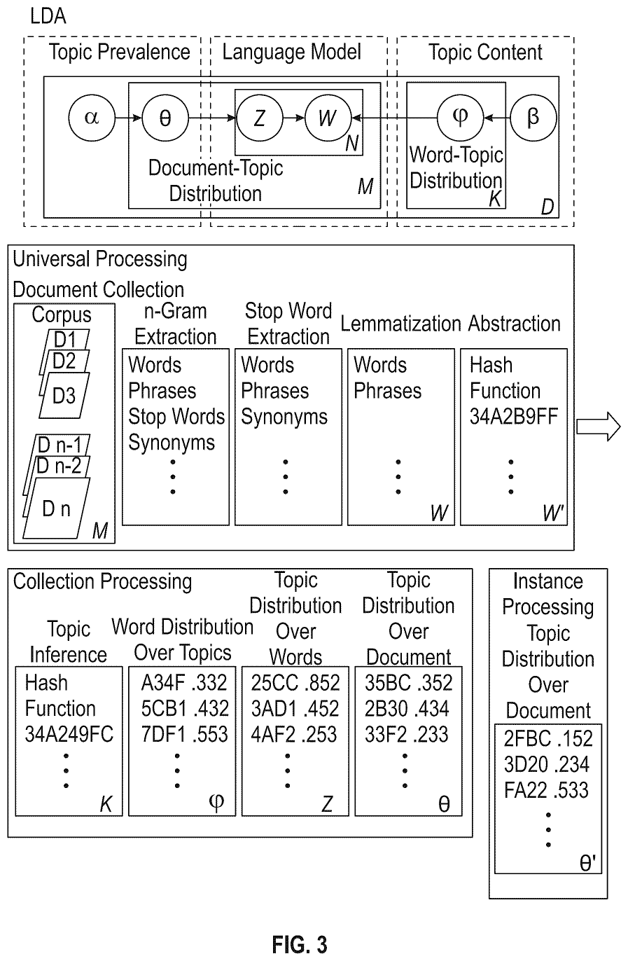

FIG. 3 illustrates an exemplary workflow for such a system. As illustrated:

Documents (D) represents the collection of documents (e.g., accessible to the system). For example, each document in the collection can be an article, a blog post, ad copy, etc.
Topics (K): a topic is a cluster in the distribution over words, indicating the likelihood of different words occurring in that topic. K is a controllable parameter, is preserved over multiple ad placements in the model, and describes the dimensionality of the model.
Words (W): an array of all words in the corpus.
Word Topic Assignment (Z): for each word in a document, there can be an associated topic. Z represents the assignment of a particular word to a particular topic.
Document Topic Distribution θ (Theta): for each document, there is a distribution over topics; θ represents a vector of the probability distribution of topics for a given document.
Topic Word Distribution, φ and β (Phi and Beta): for each topic, there is a distribution over words. φ represents a probability distribution of words for a given topic, φ are vectors of word weights per topic, K, forming a K, φ matrix. β scales the posterior training function of the word distribution vector φ integrating observed data.

N represents a number of words in a document.

M represents a number of documents in the corpus.

α (alpha) is a measure of the topical density of the Dirichlet distribution. For example, a higher α indicates that documents are likely to be composed of a mixture of most of the topics, while a lower a indicates emphasis on documents being represented by fewer topics.

In some embodiments, the system applies a variety of mathematical models useful for finding the optimal match between a set of documents and a singular reference document, which includes latent semantic analysis (LSA)/Latent Semantic Indexing (LSI), a probabilistic variant, pLSI, a Deep Learning Language Model, or any combination thereof. In some embodiments, LDA is used and performs better than LSI or pLSI.

In some embodiments, the disclosed system uses a modified version of these proven and stable statistical models by extending them to improve performance. For example, performance is improved in circumstances where specific documents to be compared are not known in advance, such as a user actively browsing text and by so doing creating a “corpus” on the fly, and where documents are too short for reliable topical discrimination, such as ads.

In some embodiments, the disclosed system improves the performance of these models relative to the existing solutions by incorporating lexical data that is logically related to the subject document but not contained within that document. Determining logical relevance relies on techniques disclosed herein, which can be expanded as such techniques are validated.

As an example, one technique to extend the scope of content is to add to the corpus representing, for example, a user's interest in information previously read. An assumption may be that older data has less relevance to current topicality than current information. A weighting function may be introduced. The weighting function may “age” derived topical weight vectors using, for example, a rolling average technique to compute a new topical weight vector that is influenced by previous browsing history of a user.

As another example, the disclosed system reviews hyperlinks contained in content or an ad, and integrates the content of the hyperlink-referenced documents into the corpus representing the ad. The system considers the computed logical distance from the subject document to the integrated document, for example, from a hyperlink contained in the subject text rather than the subject text itself, and weights the influence of the topic vector accordingly.

To improve efficiency, in some embodiments, the system advantageously does not recompute the topic weights or the n-gram vocabulary weights at each content comparison. In some embodiments, the system converts the document to be evaluated, an advertisement for example, and its related, extended content into a single topic-weighted vector which encodes the discovered latent topic weights of that ad according to the prior computed values for topics, topic weights, n-gram weights, and n-gram topicality. This operation advantageously would save computational burden.

In some embodiments, the tokens, words, and/or n-grams are part of one or more matrices (e.g., in the form of a database or table) that is globally computed and regularly updated. In some embodiments, the one or more matrices are not continuously updated of all tokens, words, and n-grams that are discriminatory between topics on one axis and the algorithmically derived topic list on another axis.

In some embodiments, both axes are hashed to normalize the data structure and to provide obfuscation of the specific lexical context (e.g., for privacy reasons). Advantageously, this operation is not a computationally complex encryption process, but it would be difficult to reverse, preserving the privacy of the user's data. For example, to crack the hashes, one would hash every n-gram and compare the values (called a rainbow table), which is a cumbersome process and harder to extract user's private data compared to cookies.

In some embodiments, some threshold and grouping are applied on some basis (e.g., per device), and form a subset of the total list which would be transmitted to a device. However, if the list is pared to data related to user device and/or user-specific then there may be a leak of device/user specific information back to the system. However, it is not passed on to advertisers because it is between the system (e.g., device 104) and the user's device, protecting the user's data from the advertiser. It could be usefully pruned/optimized by intrinsic information that the server has (IP address, therefore geolocation, preferred language, perhaps others) or campaign specific information such as publisher specific subdomains (articles, sections, etc.) or ad campaign specific the list is pruned to optimize targeting of contemporaneously on-offer advertising to maximize revenue, for example.

In some embodiments, the system compares the content the user is interacting with to the received token matrix and record matches along with at least a threshold amount of information to weight and manage a user-specific, interaction weighted list, which would form the user's device specific vector (e.g., Device Vector).

The Device Vector could represent some user data in as much as the tokens could be read as literal representations of the content the user is interacting with in a “bag of (weighted) words” format. However, advantageously, it is not a direct representation of the user's reading habits. By computing it locally, only a weighted set of contextually meaningful tokens is computed, significantly reducing the data leakage and improving privacy while enabling user-specific server-side targeting of ads and content.

To make the process of determining private data from Device Vector more difficult, a Diffie-Hellman key exchange mechanism can be used to generate a shared “salt” value between the server (e.g., device 104) and the user device, which would be used to uniquely encode the tokens. Both the list sent from the server to the device and the Device Vector returned in the form of these shared secret salted hash values. If this salt value is unique to each user, security against malicious decoding of a specific Device Vector may be established, and this can be further made resistant by frequent salt refresh with the same process.

If a unique salt value is assigned to each device, the salt values themselves may act as unique identifiers and would be known to the system (device 104). A balance between a possible leak of unique identifiers to a malicious attacker and a possible leak of encoded Device Vector content via the rainbow table decode method to a malicious hacker may be achieved by randomly assigning a salt value from a finite number of salt values such that it is both computationally difficult to hash crack the Device Vector and less individually identifying to discover the salt value. The balance of protection may be determined by the distribution of each individual salt value to users which can be quantized by individual users inclusive between unique for each and a shared value for all.

In some embodiments, the process of converting raw text to tokens is normalized, including the steps of converting words to root forms (e.g., stemming, lemmatization) and collapsing synonyms. The hashes may be meaningless in any other context than the disclosed invention and may not be reversed; as they are extracted tokens.

In some embodiments, the matrix is filled with the weighting values of tokens in discriminating the topicality of text, which may be determined by latent Dirichlet allocation, Singular Value Decomposition (SVD), by Linear Discriminant Analysis, Quadratic Discriminant Analysis (QDA), or any combination thereof.

In some embodiments, a Device Vector is computed by performing a local n-gram reduction and frequency analysis and hash, then looking up the weighting functions and computing the smaller matrix of topic hashes and weights. This topic hash and weight value may not be resolvable back to a humanly comprehensible lexical interpretation without the original (e.g., server-side) full content database and even with this, it would yield large vectors of words and weights intrinsically resistant to meaningful comprehension, protecting the user's private data. Advantageously, the disclosed Device Vectors are secure to store and have minimal privacy risks, yet still provides useful topical weights for high advertising and content presentation performance.

In some embodiments, the system (e.g., device 104) maintains a list of tokens (e.g., words, phrases, n-ples) and weights of significance. For example, proper nouns that are product-relevant would have high topical significance. This weighting matrix may be ad/content specific, not user specific, but is the raw weighting for relevance matching of content/ads to device-generated user-vectors. In some embodiments, this list is on the order of gigabytes in size.

In some embodiments, the content structure is broken up to allow updating and siloing of data. However, in some embodiments, n-gram and topic weighting functions would not be mixed up to line up topic hashes for comprehensible entity-vectors. In some embodiments, one or more the n-gram lists, word weighting functions, and the stemmed hashes of the n-grams are uniform.

In some embodiments, the system determines the weighting matrices. Over time, the optimal list of topics may change and so the computation would have to be updated globally to mitigate the inaccuracy that would arise if the topicality becomes decreasingly discriminatory. For example, some documents may have lower topicality weights for some topics over time because the topic list is out of date. In some embodiments, the weighting matrices are updated based on feedback from process Key Performance Indicators (KPIs), such as click through rate, conversion rate, time on page, automatically, manually, or algorithmically computed or sensed metrics, or any combination thereof.

In some embodiments, the n-gram list may be less consequential, since its computation is deterministic and may be extended without recomputing the topic list. However, n-gram weights may become less relevant over time as language evolves. The system may perform periodic recalculations to keep the n-gram weights relevant over time.

In some embodiments, the system recomputes Device Vectors (e.g., Content Vector, etc., as described in detail below) if a topic list is updated. In some embodiments, the system incrementally updates the Device Vectors, and historical data can be combined into the updated Device Vectors.

In some embodiments, the weighting functions are determined based on n-gram data. It may be more accurate to compute the weighting functions by actual use rather than generalized use or some other topical use, but the process of computing n-gram frequency and topicality can be determined partially on external data, such as a pre-generated corpus of words and their frequency of use. Word frequency (1-gram) may be computationally trivial even for a large dataset; however, it would become exponentially more computationally challenging as word sequences are considered, but sequences may provide greater semantic value.

In some embodiments, the user's activity is encrypted into the same space using a hash function and the topic/n-gram table. This is sent to the system (e.g., device 104) from the user device where it is compared to the ad database and ads are supplied. In some embodiments, the user device does not receive the ad vectors, though they are, like the Device Vectors, fairly inscrutable referencing an array of weights against abstract representations of topics.

In some embodiments, the system uses a modified model adapted from advertising, integrating cost function analogous to the cost function used to train neural networks through back propagation of errors computed, for example, as a least squares sum of a large set of training runs.

In some embodiments, the cost function determines value of a process to the advertiser and used as a measurable standard advertising performance metrics, including Return On Ad Spend (ROAS), Click Through Rate (CTR), conversion rate, Revenue Per Click (RPC), and Revenue Per Visitor (RPV). These metrics may provide a ground truth for optimizing parameters such as the weights in the vector-weighting vector, finding the optimal number of topics (K) for LDA calculations, finding optimal values for a and R are all incrementally refined by back propagation from the error signal provided by the cost function.

By abstracting the concept of a “document” to extended domains, the system may enable the computation of relevance beyond pair-wise optimization. In some embodiments, computing an array of such comparisons would further improve performance. In some embodiments, specific domains of content are bounded, computing relevance in a combinatorial fashion between relevant domains, and then weight the contributions in computing optimal placement. These domains may be known as “vectors” as the final comparison is to the lexical vector, a one-dimensional array of topical values and a scalar weighting function. It should be appreciated that the term vector and the specific vector names are used to facilitate the description of the disclosed systems and methods for targeting content and advertisements and are not meant to be limiting.

An Ad Vector may be defined as the topic vector for an ad and comprise expanded data from links and metadata. The expanded data may be derived from all ads in a particular campaign, the term would be a Campaign Vector.

In some embodiments, Ad Vectors are created by building a topic model for an ad from the global topic matrix and n-gram weight matrix. Because, in some instances, ads have limited text, the system (e.g., modeling engine of the system) may extend the topic model by scraping/aggregating data from additional sources directly referenced by the ad, including any pages the ad leads to (URLs) and meta information or additional information describing the ad. These topic models use a weighting function to scale the n-gram weights by lexical distance from the original source such that a topically definitional term with a high weight that is included in the ad copy itself would normally be given full topical weight while the same n-gram extracted from a linked web page would be given a lower weight. The exact weighting would be given nominal initial values. Data collected the cost function, such as computed from CTR and ROAS, would serve as ground truth and the weighting matrix would be back propagated in a manner similar to training convolutional AI models. In some instances, because the node structure is not cross-referenced and as a linear structure, the computational cost of training and calculation is advantageously linear with the number of topics, rather than exponential in both the number of nodes and the depth of the node layers as in convolutional neural networks.

A Content Vector may be defined as the topic-weighted vector for a specific article. It may include time-weighted data where it exists and is meaningful, such as revisions or modifications to the article. It may include weighted vectors derived from expanded analysis such as off-page links.

In some embodiments, content vectors are created similar to how Ad Vectors are created, except that the topic model is built from the content. In some embodiments, a “document” in NLP relevance calculations is considered as an abstract term. In the same way that ad vectors can be extended by reaching back through linked data with a weighting function, so too content vectors can be extended along links that include the entire publication, an author's work, or a publication section: any grouping that might reasonably delineate topically related content.

This delineation can be used in embodiments of the system to extend the content vector beyond the explicit bounds of the document. In some embodiments, the abstract definition of a “document” as including a corpus bounded by all works of an author or all articles in a publication can be used to create for example, Author Vectors, Section Vectors, and Publication Vectors. In some embodiments, the n-gram weighting function for topicality can also be applied. For example, an n-gram in a more recent article by a given author would be given more weight in determining the author's topicality than an n-gram appearing only in an older article.

Because authors may have followings and a consistent style, content, weighted by age and distance, from a particular author may be usefully integrated into an Author Vector.

Because publications may be thematic and attract specific demographic categories of readers to which specific demographic categories of advertisers may target, a publication's content, weighted, may be used to create a Publication Vector. In some embodiments, the Publication Vector comprises a set of content of a publication.

An Interest Vector may be defined as the topic-weighted vector for a user of a digital service derived from their interactions with the digital service and with other sources explicitly permitted and would generally include time-weighted vectors derived from aged interactions. In some embodiments, the Interest Vector comprises a set of content a visitor or user has shown interest in as algorithmically, implicitly, or explicitly determined.

In some embodiments, Interest Vectors are created by instrumenting user interaction with content to measure interaction, and in some instances, with a semi-continuous variable indicating the degree of interaction. Examples of variable interaction may be time spent on a page or on a section of text, repeat views, clicks, mouse movements, other indicators of interest, or any combination thereof.

The measure of degree of interaction is used along with other measures such as recency of interaction and subject distance from the proximate content to compute the value for the scaling function as applied to the topic weights computed for each group of content.

In some embodiments, Interest Vectors are built over a history of recorded interactions and become more detailed and more individually unique, when more content interactions can be included in the calculation of the user's interest vector. In some embodiments, the system (e.g., the model of the system) preserves the token hashes.

In some embodiments, content from a particular brand might be weighted and integrated into a Brand Vector. In some embodiments, the Brand Vector comprises a set of contextually relevant content related to a brand.

In some embodiments, each domain vector (e.g., Brand, Content, Interest, etc.) comprises an array of topic weights. The topic count, or dimensionality of the matching arrays, may be a large number, empirically optimized by cost function feedback. The optimization technique finds a minimum number of topics that is sufficiently discriminatory to enable meaningful computation of relative relevance between a reference document and an array of possible document matches.

A Vector-Weighting Vector may encode the relative weights by which multiple domain vectors can be combined to score the content under evaluation, for example an ad, for predicted performance in a specific context.

In some embodiments, the Vector-Weighting Vector (e.g., part of a weighting model) comprises a linear array of scalar values in a vector form. It is multiplied against a vector of the computed relative match between the target, for example a user's interest vector, and the domain-specific vectors relevant for content matching, for example an ad including, e.g., the Ad Vector, the Brand Vector, and the Campaign Vector. Each of these vectors encode topic weights and are multiplied by the interest vector. The sum of that array of values is multiplied by the vector-weighting vector to determine a final score. In some embodiments, the ad with the highest score is delivered to the user.

FIGS. 4A and 4B illustrate exemplary methods 400 and 450 for targeting content and advertisements, in accordance with some embodiments. In some embodiments, the steps of methods 400 and 450 are performed by one or more components described with respect to FIGS. 1-3, and 5A-5B, and/or components of system 600. For example, as illustrated, device 102 may comprise the advertisement database (Ad DB). Device 104 may comprise the ad vector database (Ad Vector DB), the content vector database (Content Vector DB), and the interest vector database (Interest Vector DB). Device 106 may comprise the content database associated with the publisher (Content DB). The device making the content request may be device 108 or 110.

It should be appreciated that steps described with respect to FIGS. 4A and 4B are exemplary. The methods 400 and 450 may include fewer steps, additional steps, or different order of steps than described. Steps of methods 400 and 450 may be performed by a different device than illustrated. Additional examples of methods 400 and 450 are described with respect to FIGS. 1-3, and 5A-5B, and it is appreciated that the steps of methods 400 and 450 leverage the features and advantages described with respect to these Figures.

As illustrated in FIG. 4A, in some embodiments, a user device transmits a content request to the publisher (step 401). The publisher receives the content request and transmits request metadata to the 2NO Servers (step 402), which may comprise the Ad Vector DB, Content Vector DB, and Interest Vector DB. The 2NO Servers receives the request metadata and transmits the request metadata to the Ad Servers (step 403). The 2NO Servers may be one or more computer servers of any suitable type and configuration.

In some embodiments, the 2NO Servers requests content update and transmits the request to the publisher (step 404). In response, the publisher transmits the requested content update to the 2NO Servers (step 405).

In some embodiments, the Ad Servers apply ad display rules (step 406), and the 2NO Servers compute Content Vectors (step 407) and compute Interest Vectors (step 408), as described herein.

In some embodiments, the Ad Servers transmits an ad inventory update to the 2NO Servers (step 409). For example, the ad inventory is updated in response to the applied ad display rules.

In some embodiments, the publisher transmits the requested content to the device (step 410), and after receiving the requested content, the device renders the content for the user (step 411).

In some embodiments, the 2NO Servers compute Ad Vectors (step 412) and optimizes advertisements (step 413), as disclosed herein. In some embodiments, the 2NO Servers transmit an ad to the publisher (step 414). For example, the ad transmitted to the publisher is a targeted ad determined using the systems and methods disclosed herein (e.g., using the Content Vectors, Interest Vectors, Ad Vectors). The publisher then transmits the ad to the user device (step 415), and after receiving the ad, the device renders the ad for the user (step 416).

In some embodiments, the 2NO Servers compute content relevance scores (step 417). For example, the 2NO Servers compute relevance scores of the requested content and use the content relevance to optimize ad targeting. The 2NO Servers transmit the content relevance scores to the publisher (step 418), and based on the received content relevance scores, the publisher determines and provides content recommendations to the user (step 419). After receiving the content recommendation, the device renders the content recommendation for the user (step 420).

In response to receiving the content recommendation, the device may request an ad (step 421).

As illustrated in FIG. 4B, in some embodiments, a user device transmits a content request to the publisher (step 451). The publisher receives the content request and transmits request metadata to the 2NO Servers (step 452), which may comprise the Ad Vector DB, Content Vector DB, and Interest Vector DB. The 2NO Servers receives the request metadata and transmits the request metadata to the Ad Servers (step 453).

In some embodiments, the 2NO Servers requests content update and transmits the request to the publisher (step 454). In response, the publisher transmits the requested content update to the 2NO Servers (step 455).

In some embodiments, the publisher transmits the requested content to the device (step 456). In some embodiments, the user device computes Content Vectors (step 457) and compute Interest Vectors (step 458), as described herein. For example, the Content Vectors and Interest Vectors are computed based on the received content. In some embodiments, after receiving the requested content, the device renders the content for the user (step 467).

In some embodiments, the user device transmits the computed Content Vectors and Interest Vectors (from steps 457 and 458) to the publisher (step 459), and the publisher transmits the received Content Vectors and Interest Vectors to the 2NO Servers (step 460).

In some embodiments, the Ad Servers apply ad display rules (step 461), and the Ad Servers transmits an ad inventory update to the 2NO Servers (step 462). For example, the ad inventory is updated in response to the applied ad display rules.

In some embodiments, the 2NO Servers compute Ad Vectors (step 463) and optimizes advertisements (step 464), as disclosed herein. For example, the advertisements are optimized based on the Ad Vectors computed by the 2NO Servers and the Content Vectors and Interest Vectors computed by the user device.

In some embodiments, the 2NO Servers transmit an ad to the publisher (step 465). For example, the ad transmitted to the publisher is a targeted ad determined using the systems and methods disclosed herein (e.g., using the Content Vectors, Interest Vectors, Ad Vectors). The publisher then transmits the ad to the user device (step 466), and after receiving the ad, the device renders the ad for the user (step 468).

In some embodiments, the 2NO Servers compute content relevance scores (step 469). For example, the 2NO Servers compute relevance scores of the requested content and use the content relevance to optimize ad targeting. The 2NO Servers transmit the content relevance scores to the publisher (step 470), and based on the received content relevance scores, the publisher determines and provides content recommendations to the user (step 471). After receiving the content recommendation, the device renders the content recommendation for the user (step 472).

In response to receiving the content recommendation, the device may request an ad (step 473).

In some embodiments, the system uses generative AI (e.g., ChatGPT or equivalents) to generate relevant summaries of articles or other semantically rich (e.g., long form) content from which high weight LSA vectors might be extracted. The system may also use generative AI to generate extended descriptions of an ad or other semantically poor (e.g., short form) content from which LSA vectors might be extracted and generate semantic descriptions of non-semantic content such as images or videos from which LSA vectors might be extracted.

This metainformation would be precomputed and stored in a database (e.g., device 104) as metadata extensions of specific content blobs on which matching is performed (e.g., extension of the operations described with respect to FIGS. 1-4).

For example, a user interacts with some combination of articles and images on a publisher's web site, this series of interactions become the basis of an Interest Vector. AI can be used to generate semantic descriptions of the images the user has interacted with as an additional input to the Interest Vector calculation.

The system may use AI to generate a summary of a set of articles, prompting AI, for example, “summarize the following articles: ‘article one . . . ’ ‘article 2 . . . ’ ‘article 3 . . . ’—and this summary may be a semantically valuable input into computing the Interest Vector.

When the publisher requests recommending an ad to fill and ad slot on the content page the user is interacting with, the system may retrieve from the database an array of ads. For each of these ads, which may have an insufficient corpus of text for meaningful semantic analysis, the additional metainformation (e.g., via AI) may be attached to the ad, the content, or linked content from the ad. The system may prompt AI to describe any images or videos in or associated with the ad as generated human-readable semantic text. The system may use AI to generate a semantic summary of any content linked to the ad.

All of this information and inputs, gathered and generated for each ad available to the publisher, would be compared to the Interest Vector to compute, as described herein, a numerical semantic relevance score of each ad to each Interest Vector. Absent other weightings or considerations, the ad with the highest score would be shown to the user.

This computation may be sufficiently computational tractable per comparison that the aggregate of all such comparisons, and may be computationally negligible in both time and watt-seconds (joules, a unit of energy).

The use of AI models advantageously allows synthesis of semantic context from limited prompts. For example, the system runs each ad and each ad image through generative AI to synthesize additional context with which to better place that ad. This would give the methods described with respect to FIGS. 1-4 an AI boost, which can, for example, improve LSA's semantic analysis capabilities at minimal cost while performing repetitious heavy work with the light-weight, efficient, semantic comparison optimized algorithms described with respect to FIGS. 1-4. Generative AI advantageously provides contextual color from a limited input while using the methods described with respect to FIGS. 1-4 for fast, efficient analysis of contextual relevance.

In some embodiments, the following operations may be performed. A visitor can initiate a process by requesting content from a publisher (e.g., one or more servers operated by a publisher). The publisher can provide the request data, to the extent it is available and shareable, and content, such as described above. After a first visit, or if the data has been spidered (e.g., captured via a web crawl process) previously, it can be cached in a database to reduce response latency on future requests. The content can trigger a Content Vector request, and one or more Content Vectors may be computed if not available. The user request can trigger a User Vector request, and one or more User Vectors can be updated, and/or computed, if not available. The content may be asynchronously delivered for AI results request and vector analysis. AI processes can be performed, including image characterization (e.g., via a generative adversarial network (GAN)) and content summation (e.g., via an LLM). In parallel, 2NO Servers can transmit an ad inventory record to an Ad Server, or multiple servers including Ad Servers with private inventory. The results can trigger an Ad Vector request, and one or more Ad Vectors may be computed (e.g., for all results) if not available. An AI summation and analysis of each of the ads can be requested and, if not precomputed, the necessary processes can be kicked off asynchronously and the results can be stored. 2NO Servers can perform a matrix vector analysis to select an ad from the available inventory (an ad that is predicted to optimize relevant KPIs), and provide it to the publisher. The publisher can format the ad and transmit it to the visitor's browser or app, which can then integrate it into an output (e.g., display and/or speakers). If the user clicks on the ad, the request data may be sent by the app or browser to the publisher, then to 2NO Servers for algorithm training and optimization; and to the publisher in parallel, which can then forward the visitor the requested content. In some embodiments, user data is not forwarded to the advertiser until the user clicks on an ad. In some embodiments, the 2NO Servers do not collect or operate on longitudinal data; and instead use live session data for computing Interest Vectors for non-logged-in visitors. In some embodiments, when permitted, 2NO Servers can utilize data from historical sessions (e.g., on a single publisher) for logged-in users. In some embodiments, AI and deep learning analysis is done only on published content and advertisements, not on users.

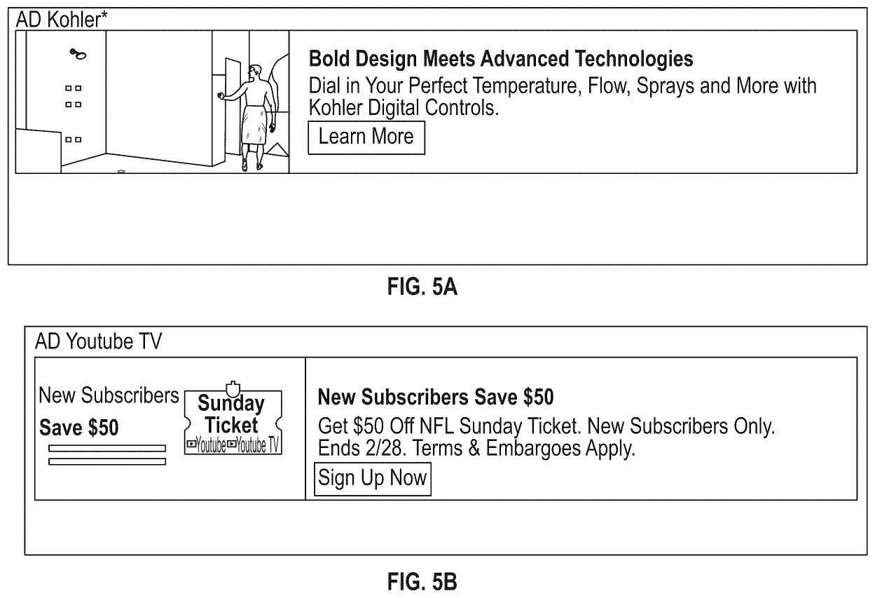

FIGS. 5A-5B illustrate exemplary advertisements, in accordance with some embodiments. These Figures show exemplary advantages of the system's use of generative AI.

Referring to FIG. 5A, the system may ask the AI “could you summarize the relevance of the following ad copy?”

For example, the system receives the following result (e.g., from ChatGPT): “The ad copy emphasizes the combination of bold design and advanced technologies in a product, likely related to bathroom or kitchen fixtures. Specifically, it highlights the use of Kohler digital controls, which allow users to customize various features such as temperature, water flow, and spray settings. The emphasis on ‘bold design’ suggests a focus on aesthetics, while the mention of ‘advanced technologies’ implies a modern and high-tech product. Overall, the ad suggests a sophisticated and customizable experience in using Kohler's fixtures.”

In some embodiments, generative AI can synthesize contextual semantics from ad images, and the system may use these AI outputs for more accurate targeting of advertisement and content.

Referring to FIG. 5A, the system may ask the AI “could you summarize the relevance of the following ad copy?”

For example, the system receives the following result (e.g., from GPT-S): “In this image, we see a man standing in a bathroom. The dominant colors are grey and black, with an accent color of 8E5F3D. The person is wearing clothing and appears to be standing in front of a mirror, possibly getting ready for the day. Behind him is a wall with a door leading to another room. In the foreground, we can see what looks like a bathtub or shower area.

The image has been analyzed by an AI model which has identified several categories including ‘others,’ ‘outdoor,’ and ‘text.’ It also notes that there is no adult or racy content present. The description tags include ‘clothing,’ ‘wall,’ ‘mirror,’ and more, giving us further insight into the elements within the image.

The caption generated by the AI model reads: ‘a person standing in a bathroom.’ This accurately describes what we see in the image but lacks detail. A more detailed caption could read: ‘A man stands confidently in his bathroom as he prepares for his day ahead.’

Further analysis from the AI model reveals that there are no landmarks present in this indoor setting. However, it does detect objects such as clothing items (possibly hanging on hooks), a bathtub/shower area, and even identifies specific objects like gloves and curtains.

We can also see that there are no other people visible in this scene besides our main subject. This adds to the feeling of privacy and solitude within this personal space.

Overall, this high-quality PNG image captures an intimate moment of someone's daily routine while providing valuable information about its contents through advanced AI technology.”

Referring to FIG. 5B, the system may ask the AI “could you summarize the relevance of the following ad copy?”

For example, the system receives the following result (e.g., from ChatGPT): “The ad copy promotes a $50 discount on the NFL Sunday Ticket for new subscribers. The offer is time-limited, ending on February 28th, and certain terms and embargoes apply. This advertisement targets individuals who are not currently subscribed to the NFL Sunday Ticket service, enticing them to sign up by offering a discount.”

In some embodiments, generative AI can synthesize contextual semantics from ad images, and the system may use these AI outputs for more accurate targeting of advertisement and content.

For example, the system receives the following result (e.g., from GPT-S): “This image is a screenshot of a green banner displayed on a football field. The banner features white text and appears to be promoting a sports game. The dominant colors in the image are black and green, with accents of red. The background is primarily composed of grass, adding to the overall sports theme.

The text on the banner reads “a coupon for your next game,” indicating that it may be offering some sort of discount or promotion for attendees. The font used is bold and eye-catching, making it easy to read from a distance. In addition to the main banner, there are also smaller signs scattered throughout the field advertising various brands and sponsors.

The overall design of the banner is simple yet effective, with its contrasting colors and clear messaging drawing attention from viewers. It's placed strategically near one end of the field, ensuring maximum visibility for those watching from both sides.

In this close-up shot, we can see details such as blades of grass poking through parts of the sign's surface, giving it an organic feel that ties in nicely with its surroundings. Despite being slightly blurry due to movement or zooming in too closely during capture, all elements within this image remain easily identifiable.

Overall, this image captures not only an advertisement but also conveys a sense of excitement and anticipation for an upcoming sporting event. With its vibrant colors and clear messaging, it effectively promotes both brand awareness and ticket sales while blending seamlessly into its environment on game day.”

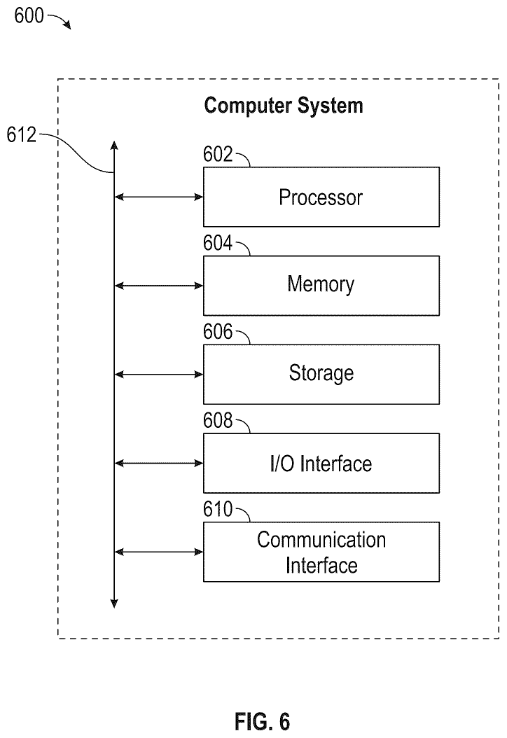

FIG. 6 illustrates an example computer system 600. In some embodiments, a disclosed system comprises the computer system 600. For example, one or more of devices of system 100 comprise the computer system 600. As another example, one or more devices performing the method 400 or 450 comprise the computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a rack-mounted server, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, display, mouse, printer, scanner, speaker, still camera, stylus, tablet, touch screen, trackball, video camera, sensors, magnetic detectors, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface. The one or more I/O devices may be configured to display a graphical user interface for selection of available visit times.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

In some embodiments, a non-transitory computer readable storage medium stores one or more programs, and the one or more programs includes instructions. When the instructions are executed by an electronic device (e.g., computer system 600) with one or more processors and memory, the instructions cause the electronic device to perform the methods described with respect to FIGS. 1-5B.

In some embodiments, a method comprises receiving a request for a first advertisement for a user; determining one or more domain vectors associated with the user, wherein the one or more domain vectors indicate a suitability of an advertisement for the users; determining from a plurality of advertisements, based on the one or more domain vectors, the first advertisement; and transmitting the first advertisement.

In some embodiments, a method comprises receiving a request for a first advertisement for a content; determining one or more domain vectors associated with the content, wherein the one or more domain vectors indicate a suitability of an advertisement for the content; determining from a plurality of advertisements, based on the one or more domain vectors, the first advertisement for the content; and transmitting the first advertisement for the content.

In some embodiments, a method comprises receiving a plurality of requests a first advertisement from a plurality of users; determining one or more domain vectors associated with each of the users, wherein the one or more domain vectors indicate a suitability of a user for the first advertisement; determining from the plurality of users, based on the one or more domain vectors, the first user; and transmitting the first advertisement to the first user.

In some embodiments, a method comprises receiving a plurality of requests for a first advertisement for a plurality of content; determining one or more domain vectors associated with each of the content, wherein the one or more domain vectors indicate a suitability of a content for the first advertisement; determining from the plurality of content, based on the one or more domain vectors, the first content; and transmitting the advertisement for the first content.

In some embodiments, a method comprises receiving a plurality of requests for a first advertisement for a plurality of content; determining one or more domain vectors associated with each of the content, wherein the one or more domain vectors indicate an adverse suitability of a content for the advertisement; determining from a plurality of content, based on the one or more domain vectors, inappropriate content; and forgoing transmitting the first advertisement for the inappropriate content.

In some embodiments, a method comprises receiving a request for a first advertisement; determining one or more domain vectors, wherein the one or more domain vectors indicate a suitability of an advertisement; determining, from a plurality of advertisements, based on the one or more domain vectors, the first advertisement; and transmitting the first advertisement. In some embodiments, the first advertisement comprises a first advertisement for a user; the one or more domain vectors are associated with the user; and the suitability of the advertisement comprises a suitability of the advertisement for the user. In some embodiments, the first advertisement comprises a first advertisement for a content item; the one or more domain vectors are associated with the content item; and the suitability of the advertisement comprises a suitability of the advertisement for the content item. In some embodiments, the method further comprises receiving a plurality of advertisement requests from a plurality of users, wherein the plurality of requests comprises the request for the first advertisement; determining one or more domain vectors associated with each of the users, wherein each of the one or more domain vectors indicates a suitability of a respective user of the plurality of users for the first advertisement; determining, based on the one or more domain vectors, a first user of the plurality of users; and transmitting the first advertisement to the first user. In some embodiments, the method further comprises receiving a plurality of advertisement requests from a plurality of content items, wherein the plurality of requests comprises the request for the first advertisement; determining one or more domain vectors associated with each of the content items, wherein each of the one or more domain vectors indicates a suitability of a respective content item for the first advertisement; and determining, based on the one or more domain vectors, a first content item of the plurality of content items; wherein the first advertisement is associated with the first content item. In some embodiments, the method further comprises determining, based on the one or more domain vectors, that a content item comprises inappropriate content; and forgoing transmitting an advertisement associated with the inappropriate content.

In some embodiments, the method further comprises identifying a non-semantic element of the content item; determining a unique index value based on a hash of the non-semantic element of the content item; querying a database based on the unique index value; in response to a determination, based on said querying, that the unique index value exists in the database: receiving, from the database, a first semantic description of the non-semantic element of the content item, associating the first semantic description with the semantic element of the content item, and determining a first vector based on the content item; and in response to a determination, based on said querying, that the unique index value does not exist in the database: applying the non-semantic element of the content item as input to a generative AI model, receiving an output of the generative AI model, the output comprising a second semantic description of the non-semantic element of the content item, storing the second semantic description of the non-semantic element of the content item in the database, wherein the second semantic description is indexed in the database by the unique hash value, associating the second semantic description with the semantic element of the content item, and determining a second vector based on the content item.

In some embodiments, a non-transitory computer-readable medium stores instructions that, when executed by one or more processors, cause the one or more processors to perform the above methods.

In some embodiments, a system comprises one or more processors configured to perform the above methods.

Those skilled in the art will recognize that the systems described herein are representative, and deviations from the explicitly disclosed embodiments are within the scope of the disclosure.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

1. A method comprising:
receiving a request for a first advertisement;
determining one or more domain vectors, wherein the one or more domain vectors indicate a suitability of an advertisement;
determining, from a plurality of advertisements, based on the one or more domain vectors, the first advertisement; and
transmitting the first advertisement.

2. The method of claim 1, wherein:
the first advertisement comprises a first advertisement for a user;
the one or more domain vectors are associated with the user; and
the suitability of the advertisement comprises a suitability of the advertisement for the user.

3. The method of claim 1, wherein:
the first advertisement comprises a first advertisement for a content item;
the one or more domain vectors are associated with the content item; and
the suitability of the advertisement comprises a suitability of the advertisement for the content item.

4. The method of claim 1, further comprising:
receiving a plurality of advertisement requests from a plurality of users, wherein the plurality of requests comprises the request for the first advertisement;
determining one or more domain vectors associated with each of the users, wherein each of the one or more domain vectors indicates a suitability of a respective user of the plurality of users for the first advertisement;
determining, based on the one or more domain vectors, a first user of the plurality of users; and
transmitting the first advertisement to the first user.

5. The method of claim 1, further comprising:
receiving a plurality of advertisement requests from a plurality of content items, wherein the plurality of requests comprises the request for the first advertisement;
determining one or more domain vectors associated with each of the content items, wherein each of the one or more domain vectors indicates a suitability of a respective content item for the first advertisement; and
determining, based on the one or more domain vectors, a first content item of the plurality of content items;
wherein the first advertisement is associated with the first content item.

6. The method of claim 5, further comprising:
determining, based on the one or more domain vectors, that a content item comprises inappropriate content; and
forgoing transmitting an advertisement associated with the inappropriate content.

7. The method of claim 3, further comprising:
identifying a non-semantic element of the content item;
determining a unique index value based on the non-semantic element of the content item;
querying a database based on the unique index value;
in response to a determination, based on said querying, that the unique index value exists in the database:
receiving, from the database, a first semantic description of the non-semantic element of the content item,
associating the first semantic description with the semantic element of the content item, and
determining a first vector based on the content item; and
in response to a determination, based on said querying, that the unique index value does not exist in the database:
applying the non-semantic element of the content item as input to a generative AI model,
receiving an output of the generative AI model, the output comprising a second semantic description of the non-semantic element of the content item,
storing the second semantic description of the non-semantic element of the content item in the database, wherein the second semantic description is indexed in the database by the unique hash value,
associating the second semantic description with the semantic element of the content item, and
determining a second vector based on the content item.

8. A system comprising:
one or more processors configured to perform a method comprising:
receiving a request for a first advertisement;
determining one or more domain vectors, wherein the one or more domain vectors indicate a suitability of an advertisement;
determining, from a plurality of advertisements, based on the one or more domain vectors, the first advertisement; and
transmitting the first advertisement.

9. The system of claim 8, wherein:
the first advertisement comprises a first advertisement for a user;
the one or more domain vectors are associated with the user; and
the suitability of the advertisement comprises a suitability of the advertisement for the user.

10. The system of claim 8, wherein:
the first advertisement comprises a first advertisement for a content item;
the one or more domain vectors are associated with the content item; and
the suitability of the advertisement comprises a suitability of the advertisement for the content item.

11. The system of claim 8, further comprising:
receiving a plurality of advertisement requests from a plurality of users, wherein the plurality of requests comprises the request for the first advertisement;
determining one or more domain vectors associated with each of the users, wherein each of the one or more domain vectors indicates a suitability of a respective user of the plurality of users for the first advertisement;
determining, based on the one or more domain vectors, a first user of the plurality of users; and
transmitting the first advertisement to the first user.

12. The system of claim 8, wherein the method further comprises:
receiving a plurality of advertisement requests from a plurality of content items, wherein the plurality of requests comprises the request for the first advertisement;
determining one or more domain vectors associated with each of the content items, wherein each of the one or more domain vectors indicates a suitability of a respective content item for the first advertisement; and
determining, based on the one or more domain vectors, a first content item of the plurality of content items;
wherein the first advertisement is associated with the first content item.

13. The system of claim 12, wherein the method further comprises:
determining, based on the one or more domain vectors, that a content item comprises inappropriate content; and
forgoing transmitting an advertisement associated with the inappropriate content.

14. The system of claim 10, wherein the method further comprises:
identifying a non-semantic element of the content item;
determining a unique index value based on the non-semantic element of the content item;
querying a database based on the unique index value;
in response to a determination, based on said querying, that the unique index value exists in the database:
receiving, from the database, a first semantic description of the non-semantic element of the content item,
associating the first semantic description with the semantic element of the content item, and
determining a first vector based on the content item; and
in response to a determination, based on said querying, that the unique index value does not exist in the database:
applying the non-semantic element of the content item as input to a generative AI model,
receiving an output of the generative AI model, the output comprising a second semantic description of the non-semantic element of the content item,
storing the second semantic description of the non-semantic element of the content item in the database, wherein the second semantic description is indexed in the database by the unique hash value,
associating the second semantic description with the semantic element of the content item, and
determining a second vector based on the content item.

15. A non-transitory computer-readable medium storing instructions which, when executed by one or more processors, cause the one or more processors to perform a method comprising:
receiving a request for a first advertisement;
determining one or more domain vectors, wherein the one or more domain vectors indicate a suitability of an advertisement;
determining, from a plurality of advertisements, based on the one or more domain vectors, the first advertisement; and
transmitting the first advertisement.

16. The non-transitory computer-readable medium of claim 15, wherein:
the first advertisement comprises a first advertisement for a user;
the one or more domain vectors are associated with the user; and
the suitability of the advertisement comprises a suitability of the advertisement for the user.

17. The non-transitory computer-readable medium of claim 15, wherein:
the first advertisement comprises a first advertisement for a content item;
the one or more domain vectors are associated with the content item; and
the suitability of the advertisement comprises a suitability of the advertisement for the content item.

18. The non-transitory computer-readable medium of claim 15, further comprising:
receiving a plurality of advertisement requests from a plurality of users, wherein the plurality of requests comprises the request for the first advertisement;
determining one or more domain vectors associated with each of the users, wherein each of the one or more domain vectors indicates a suitability of a respective user of the plurality of users for the first advertisement;
determining, based on the one or more domain vectors, a first user of the plurality of users; and
transmitting the first advertisement to the first user.

19. The non-transitory computer-readable medium of claim 15, further comprising:
receiving a plurality of advertisement requests from a plurality of content items, wherein the plurality of requests comprises the request for the first advertisement;
determining one or more domain vectors associated with each of the content items, wherein each of the one or more domain vectors indicates a suitability of a respective content item for the first advertisement; and
determining, based on the one or more domain vectors, a first content item of the plurality of content items;
wherein the first advertisement is associated with the first content item.

20. The non-transitory computer-readable medium of claim 17, further comprising:
identifying a non-semantic element of the content item;
determining a unique index value based on the non-semantic element of the content item;
querying a database based on the unique index value;
in response to a determination, based on said querying, that the unique index value exists in the database:
receiving, from the database, a first semantic description of the non-semantic element of the content item,
associating the first semantic description with the semantic element of the content item, and
determining a first vector based on the content item; and
in response to a determination, based on said querying, that the unique index value does not exist in the database:
applying the non-semantic element of the content item as input to a generative AI model,
receiving an output of the generative AI model, the output comprising a second semantic description of the non-semantic element of the content item,
storing the second semantic description of the non-semantic element of the content item in the database, wherein the second semantic description is indexed in the database by the unique hash value,
associating the second semantic description with the semantic element of the content item, and
determining a second vector based on the content item.
